(19) United States
(12) Patent Application Publication
(10) Pub. No.: US 2017/0080286 A1
(43) Pub. Date: Mar. 23, 2017

(54) SPORTS PERFORMANCE DATA CHIP

(71) Applicants: Daniel Sullivan, Corona, CA (US); Kimberly Sullivan, Corona, CA (US)

(72) Inventors: Daniel Sullivan, Corona, CA (US); Kimberly Sullivan, Corona, CA (US)

(21) Appl. No.: 14/858,085

(22) Filed: Sep. 18, 2015

(51) Int. Cl. A63B 24/00; A63B 69/00; A63B 69/36; H04B 1/38

(52) U.S. Cl. CPC A63B 24/0003; H04B 1/38; A63B 69/0002; A63B 69/36; A63B 2069/0008; A63B 2208/0204; A63B 2220/40; A63B 2220/833

(57) ABSTRACT

A sports performance data chip includes a striking implement that may be utilized for athletic purposes. A projectile is provided that may be utilized for athletic purposes. A base unit is positioned within the striking implement. Thus, the base unit detects and records motion of the striking implement when the striking implement is swung. A remote unit is positioned within the projectile. Thus, the remote unit detects and records motion of the projectile when the projectile is struck with the striking implement.

### BACKGROUND OF THE DISCLOSURE

### Field of the Disclosure

The disclosure relates to training devices and more particularly pertains to a new training device for recording performance data of a striking implement and a projectile.

### SUMMARY OF THE DISCLOSURE

An embodiment of the disclosure meets the needs presented above by generally comprising a striking implement that may be utilized for athletic purposes. A projectile is provided that may be utilized for athletic purposes. A base unit is positioned within the striking implement. Thus, the base unit detects and records motion of the striking implement when the striking implement is swung. A remote unit is positioned within the projectile. Thus, the remote unit detects and records motion of the projectile when the projectile is struck with the striking implement.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a sports performance data chip according to an embodiment of the disclosure.

FIG. 2 is a bottom view of an embodiment of the disclosure.

FIG. 3 is a perspective in-use view of an embodiment of the disclosure.

FIG. 4 is a side perspective in-use view of an embodiment of the disclosure.

FIG. 5 is a schematic view of an embodiment of the disclosure.

### DESCRIPTION OF THE PREFERRED EMBODIMENT

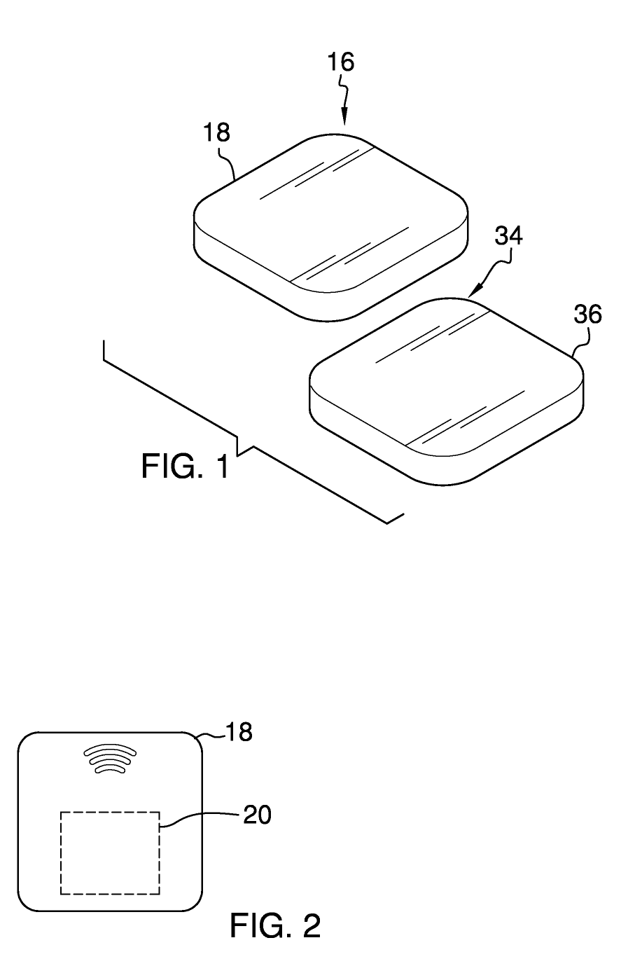

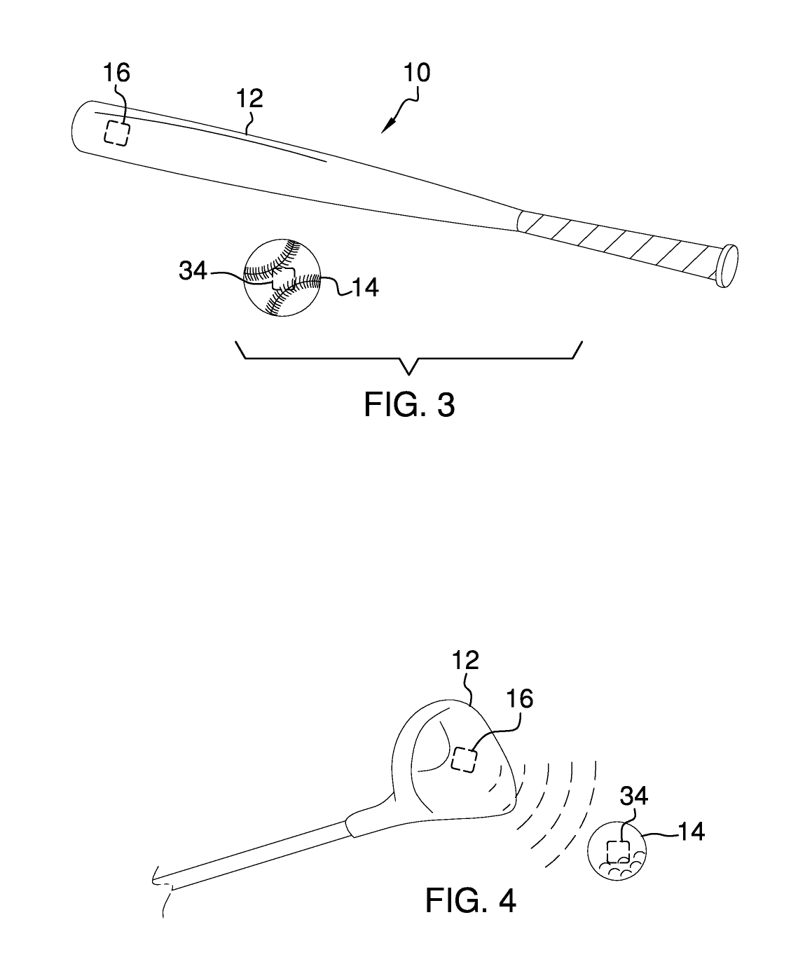

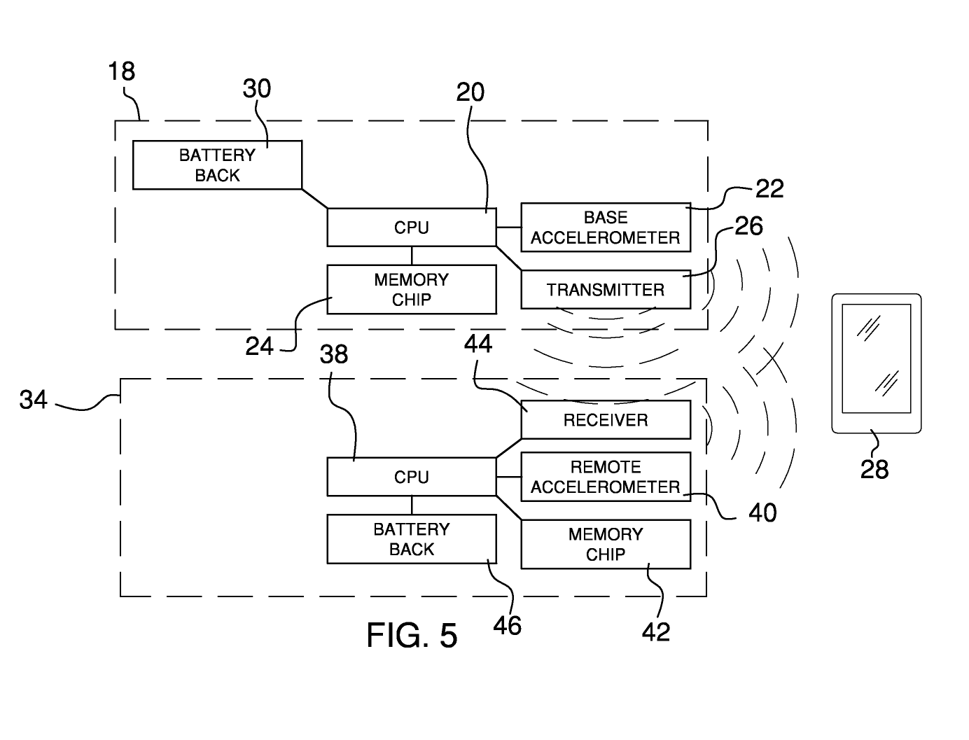

With reference now to the drawings, and in particular to FIGS. 1 through 5 thereof, a new training device embodying the principles and concepts of an embodiment of the disclosure and generally designated by the reference numeral 10 will be described.

As best illustrated in FIGS. 1 through 5, the sports performance data chip 10 generally comprises a striking implement 12 that may be utilized for athletic purposes. The striking implement 12 may comprise a baseball bat, a golf club, a hockey stick or other striking implement 12 utilized to strike a projectile 14 in the convention of athletic competition. A projectile 14 is provided that is selectively struck by the striking implement 12. The projectile 14 may comprise a ball, a hockey puck or other projectile 14 that is struck with the striking implement 12 in the convention of athletic competition.

A base unit 16 is provided and the base unit 16 positioned within the striking implement 12. Thus, the base unit 16 detects and records motion of the striking implement 12 when the striking implement 12 is swung. The base unit 16 comprises a base housing 18 is positioned within the striking implement 12 and a base control circuit 20 that is positioned within the base housing 18. The base control circuit 20 may comprise an electronic processor or the like.

A base accelerometer 22 is positioned within the base housing 18 thereby facilitating the base accelerometer 22 to detect a velocity of the striking implement 12 when the striking implement 12 is swung. The base accelerometer 22 generates striking performance data relating to the striking implement 12 and the base accelerometer 22 is electrically coupled to the base control circuit 20. The striking performance data may include an acceleration of the striking implement 12, a force generated by the striking implement 12, a moment of the striking implement 12, a total duration of time the striking implement 12 is in motion and other physical data relating to the motion of the striking implement 12 through space.

A base electronic memory 24 is provided and the base electronic memory 24 is positioned within the base housing 18. The base electronic memory 24 is electrically coupled to the base control circuit 20 such that the base electronic memory 24 stores the striking performance data. The base electronic memory 24 may comprise RAM memory or the like.

A base transceiver 26 is positioned within the base housing 18 and the base transceiver 26 is electrically coupled to the base control circuit 20. Thus, the base transceiver 26 receives the striking performance data from the base electronic memory 24. The base transceiver 26 may be in electrical communication with an extrinsic electronic device 28 and the extrinsic electronic device 28 may be a personal computer or the like. Thus, the base transceiver 26 may communicate the striking performance data to the extrinsic electronic device 28. The base transceiver 26 may comprise a radio frequency transceiver or the like.

A base power supply 30 is provided and the base power supply 30 is positioned within the base housing 18. The base power supply 30 is electrically coupled to the base control circuit 20 and the base power supply 30 comprises at least one battery 32.

A remote unit 34 is provided and the remote unit 34 is positioned within the projectile 14. Thus, the remote unit 34 detects and records motion of the projectile 14 when the projectile 14 is struck with the striking implement 12. The remote unit 34 comprises a remote housing 36 that is positioned within the projectile 14. A remote control circuit 38 is positioned within the remote housing 36 and the remote control circuit 38 may comprise an electronic processor or the like.

A remote accelerometer 40 is positioned within the remote housing 36 such that the remote accelerometer 40 detects a velocity of the projectile 14 when the projectile 14 is struck with the striking implement 12. The remote accelerometer 40 generates projectile performance data relating to the projectile 14 and the remote accelerometer 40 is electrically coupled to the remote control circuit 38. The projectile performance data may include a moment of the projectile 14, an acceleration and a deceleration of the projectile 14, a total flight time of the projectile 14 and other physical data relating to the motion of the projectile 14 through space.

A remote electronic memory 42 is provided and the remote electronic memory 42 is positioned within the remote housing 36. The remote electronic memory 42 is electrically coupled to the remote control circuit 38 such that the remote electronic memory 42 stores the projectile performance data. The remote electronic memory 42 may comprise RAM memory or the like.

A remote transceiver 44 is positioned within the remote housing 36 and the remote transceiver 44 is electrically coupled to the remote control circuit 38. Thus, the remote transceiver 44 receives the projectile performance data from the remote electronic memory 42. The remote transceiver 44 is in electrical communication with the base transceiver 26 and the remote transceiver 44 may be in electrical communication with the extrinsic electronic device 28. Thus, the remote transceiver 44 may communicate the projectile performance data to the extrinsic electronic device 28. The remote transceiver 44 may comprise a radio frequency transceiver or the like.

A remote power supply 46 is positioned within the remote housing 36. The remote power supply 46 is electrically coupled to the remote control circuit 38. The remote power supply 46 comprises at least one battery 48.

In use, the striking implement 12 and the projectile 14 are utilized in the convention of athletic competition. The striking performance data and the projectile performance data are downloaded into the extrinsic electronic device 28 for analysis. The striking performance data and the projectile performance data are compiled into categories such as the longest distance the projectile travels, the fastest swing of the striking implement, the highest force generated by the striking implement and other performance statistics. Additionally, the striking performance data and the projectile performance data are analyzed to determine deficiencies in the utilization of the striking implement 12 thereby facilitating the deficiencies to be corrected.

The base unit 16 may be utilized independently of the remote unit 34. The base unit 16 may be positioned within any article of athletic equipment to include a pair of shoes, a ball, or any article of athletic equipment. A plurality of the base units 16 may each be coupled to an associated one of a group of athletic articles of a football team, for example. The plurality of base units 16 records the performance data of the group of athletic articles as independent units. Thus, all aspects of the football team's performance data may be analyzed independently or in aggregate.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A sports performance data chip system for detecting and recording motion of athletic implements, said system comprising:
a striking implement configured to be utilized for athletic purposes;
a projectile configured to be utilized for athletic purposes;
a base unit being positioned within said striking implement thereby facilitating said base unit to detect and record motion of said striking implement when said striking implement is swung; and
a remote unit being positioned within said projectile thereby facilitating said remote unit to detect and record motion of said projectile when said projectile is struck with said striking implement.

2. The system according to claim 1, wherein and said base unit comprises:
a base housing being positioned within said striking implement; and
a base control circuit being positioned within said base housing.

3. The system according to claim 2, further comprising a base accelerometer being positioned within said base housing wherein said base accelerometer detects a velocity of said striking implement when said striking implement is swung, said base accelerometer generating striking performance data relating to said striking implement, said base accelerometer being electrically coupled to said base control circuit.

4. The system according to claim 3, further comprising a base electronic memory being positioned within said base housing, said base electronic memory being electrically coupled to said base control circuit wherein said base electronic memory stores said striking performance data.

5. The system according to claim 4, further comprising a base transceiver being positioned within said base housing, said base transceiver being electrically coupled to said base control circuit wherein said base transceiver receives said striking performance data from said base electronic memory, said base transceiver being configured to be in electrical communication with an extrinsic electronic device.

6. The system according to claim 2, further comprising a base power supply being positioned within said base housing, said base power supply being electrically coupled to said base control circuit, said base power supply comprising at least one battery.

7. The system according to claim 1, wherein said remote unit comprises:
a remote housing being positioned within said projectile; and
a remote control circuit being positioned within said remote housing.

8. The system according to claim 7, further comprising a remote accelerometer being positioned within said remote housing wherein said remote accelerometer detects a velocity of said projectile when said projectile is struck with said striking implement, said remote accelerometer generating projectile performance data relating to said projectile, said remote accelerometer being electrically coupled to said remote control circuit.

9. The system according to claim 8, further comprising a remote electronic memory being positioned within said remote housing, said remote electronic memory being electrically coupled to said remote control circuit wherein said remote electronic memory stores said projectile performance data.

10. The system according to claim 9, further comprising:
a base transceiver; and
a remote transceiver being positioned within said remote housing, said remote transceiver being electrically coupled to said remote control circuit wherein said remote transceiver receives said projectile performance data from said remote electronic memory, said remote transceiver being in electrical communication with said base transceiver, said remote transceiver being configured to be in electrical communication with the extrinsic electronic device.

11. The system according to claim 7, further comprising a remote power supply being positioned within said remote housing, said remote power supply being electrically coupled to said remote control circuit, said remote power supply comprising at least one battery.

12. A sports performance data chip system for detecting and recording motion of athletic implements, said system comprising:
a striking implement configured to be utilized for athletic purposes;
a projectile configured to be utilized for athletic purposes;
a base unit being positioned within said striking implement thereby facilitating said base unit to detect and record motion of said striking implement when said striking implement is swung; and said base unit comprising:
a base housing being positioned within said striking implement,
a base control circuit being positioned within said base housing,
a base accelerometer being positioned within said base housing wherein said base accelerometer detects a velocity of said striking implement when said striking implement is swung, said base accelerometer generating striking performance data relating to said striking implement, said base accelerometer being electrically coupled to said base control circuit,
a base electronic memory being positioned within said base housing, said base electronic memory being electrically coupled to said base control circuit wherein said base electronic memory stores said striking performance data,
a base transceiver being positioned within said base housing, said base transceiver being electrically coupled to said base control circuit wherein said base transceiver receives said striking performance data from said base electronic memory, said base transceiver being configured to be in electrical communication with an extrinsic electronic device, and
a base power supply being positioned within said base housing, said base power supply being electrically coupled to said base control circuit, said base power supply comprising at least one battery;
a remote unit being positioned within said projectile thereby facilitating said remote unit to detect and record motion of said projectile when said projectile is struck with said striking implement, said remote unit comprising:
a remote housing being positioned within said projectile,
a remote control circuit being positioned within said remote housing,
a remote accelerometer being positioned within said remote housing wherein said remote accelerometer detects a velocity of said projectile when said projectile is struck with said striking implement, said remote accelerometer generating projectile performance data relating to said projectile, said remote accelerometer being electrically coupled to said remote control circuit,
a remote electronic memory being positioned within said remote housing, said remote electronic memory being electrically coupled to said remote control circuit wherein said remote electronic memory stores said projectile performance data,
a remote transceiver being positioned within said remote housing, said remote transceiver being electrically coupled to said remote control circuit wherein said remote transceiver receives said projectile performance data from said remote electronic memory, said remote transceiver being in electrical communication with said base transceiver, said remote transceiver being configured to be in electrical communication with the extrinsic electronic device, and
a remote power supply being positioned within said remote housing, said remote power supply being electrically coupled to said remote control circuit, said remote power supply comprising at least one battery.
